(19) United States
(12) Patent Application Publication
(10) Pub. No.: US 2024/0422802 A1
(43) Pub. Date: Dec. 19, 2024

(54) MANAGING POINT-TO-POINT AND POINT-TO-MULTIPOINT TRANSMISSION

(71) Applicant: GOOGLE LLC, Mountain View, CA (US)

(72) Inventor: Chih-Hsiang Wu, Taoyuan City (TW)

(21) Appl. No.: 18/701,214

(22) PCT Filed: Oct. 13, 2022
(86) PCT No.: PCT/US22/46521

§ 371 Date: Apr. 12, 2024

Related U.S. Application Data
(60) Provisional application No. 63/255,941, filed on Oct. 14, 2021.

(51) Int. Cl. H04W 72/30; H04W 28/02; H04W 76/12

(52) U.S. Cl. CPC H04W 72/30; H04W 28/0268; H04W 76/12

(57) ABSTRACT

To manage transmission of multicast and/or broadcast services (MBS), a base station receives, from a core network (CN), a request to configure a common tunnel associated with an MBS session, via which the base station is to receive MBS data, from the CN, for wireless transmission to multiple user equipment (UEs) (1902). In response to the request, the base station transmits, to the CN, a configuration of the common tunnel (1904).

### FIELD OF THE DISCLOSURE

This disclosure relates to wireless communications and, more particularly, to enabling setup and/or modification of radio resources for multicast and/or broadcast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the ce″lls associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR. 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station receives an MBS data packet from a core network and how the base station transmits each MBS data packet to UEs.

### SUMMARY

Using the techniques of this disclosure, a core network (CN) and a base station communicate MBS traffic for multiple UEs via a shared (or “common”) tunnel between the CN and the base station. The base station can generate and provide the configuration of the common tunnel, such as an Internet Protocol (IP) address and/or a Tunnel Endpoint Identifier (TEID), to the CN in response to a request for the configuration from the CN.

An example embodiment of these techniques is a method in a base station for managing transmission of multicast and/or broadcast services (MBS). The method includes receiving, by processing hardware from a core network (CN), a request to configure a common tunnel associated with an MBS session, via which the base station is to receive MBS data, from the CN, for wireless transmission to multiple user equipment (UEs); and in response to the request, transmitting, by the processing hardware to the CN, a configuration of the common tunnel.

Another example embodiment of these techniques is a method in a base station for managing transmission of MBS, the method comprising: receiving, by processing hardware from a CN, a first message indicating that a first UE has joined an MBS session; and in response to the first message, transmitting, by the processing hardware to the CN, a configuration for a tunnel via which the base station is to receive, from the CN, MBS data for the MBS session; receiving, by the processing hardware from the CN, a second message indicating that a second UE has joined the MBS session; and in response to the second message, transmitting, by the processing hardware to the CN, the configuration.

Yet another example embodiment of these techniques is a base station including processing hardware and configured to implement one of the methods above.

Another example embodiment of these techniques is a method in a CN for managing transmission of MBS, the method comprising: transmitting, by processing hardware to a base station, a request to configure a tunnel associated with an MBS session, via which the CN is to transmit MBS data to the base station for wireless transmission to multiple UEs; and receiving, by the processing hardware from the base station, a configuration of the tunnel.

Still another example embodiment of these techniques is a CN including processing hardware and configured to implement the method above.

### BRIEF DESCRIPTION OF THE DRAWINGS

FIG. 1A is a block diagram of an example system in which the techniques of this disclosure for managing transmission and reception of MBS information can be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions, respectively;

FIG. 4 is a messaging diagram of an example scenario in which a CN and a base station establish a common downlink (DL) tunnel via which the CN can transmit MBS data of an MBS session, for multiple UEs, to the base station;

FIG. 5 is a flow diagram of an example method for configuring a logical channel associated with a DL tunnel and transmitting MBS data to one or more UEs via the logical channel, which can be implemented in a base station of FIG. 1A;

FIG. 6 is a flow diagram of an example method for configuring a logical channel associated with an MBS quality of service (QOS) flow for an MBS session, and transmitting MBS data of the MBS QoS flow to one or more UEs via the logical channel, which can be implemented in a base station of FIG. 1A;

FIG. 7 is a flow diagram of an example method for configuring a logical channel associated with multiple MBS QoS flows for an MBS session, and transmitting MBS data of the MBS QoS flows to one or more UEs via the logical channel, which can be implemented in a base station of FIG. 1A;

FIG. 8A is a flow diagram of an example method for determining which logical channel to use to transmit a data packet to a UE based on whether the data packet was received via a DL tunnel associated with an MBS session or a PDU session, which can be implemented in a base station of FIG. 1A;

FIG. 8B is a flow diagram of an example method for determining which logical channel to use to transmit a data packet to a UE based on whether the data packet was received via a common DL tunnel or a UE-specific DL tunnel, which can be implemented in a base station of FIG. 1A;

FIG. 8C is a flow diagram of an example method for determining which logical channel to use to transmit a data packet to a UE based on the tunnel via which the data packet was received, which can be implemented in a base station of FIG. 1A;

FIG. 9 is a flow diagram of an example method for determining which logical channel to use to transmit a data packet to a UE based on whether the data packet is associated with a broadcast session or a multicast session, which can be implemented in a base station of FIG. 1A;

FIG. 10 is a flow diagram of another example method for determining which logical channel to use to transmit a data packet to the UE based on the tunnel via which the data packet was received, which can be implemented in a base station of FIG. 1A;

FIG. 11 is a flow diagram of an example method for configuring an MRB and a DRB for an MBS session and a PDU session, respectively, which can be implemented in a base station of FIG. 1A;

FIGS. 12A-12B are flow diagrams of example methods for receiving MBS data packets of an MBS session via a multicast traffic channel (MTCH) or a dedicated traffic channel (DTCH), respectively, which can be implemented in a UE of FIG. 1A;

FIG. 13 is a flow diagram of an example method for using a UE-specific procedures to establish a common DL tunnel, which can be implemented in a base station of FIG. 1A;

FIG. 14 is a flow diagram of an example method for determining whether to configure a DL tunnel for an MBS session in response to receiving a CN-to-BS message indicating that a UE has joined the MBS session, which can be implemented in a base station of FIG. 1A;

FIG. 15 is a flow diagram of an example method for establishing a common DL tunnel associated with an MBS session, which can be implemented in a CN of FIG. 1A;

FIG. 16 is a flow diagram of an example method for determining whether to configure a DL tunnel for an MBS session in response to a UE joining the MBS session, which can be implemented in a CN of FIG. 1A;

FIG. 17 is a flow diagram of an example method for determining whether to include an uplink (UL) transport layer configuration in a CN-to-BS message requesting resources for a session based on whether the session is a PDU session or an MBS session, which can be implemented by a CN of FIG. 1A;

FIG. 18 is a flow diagram of an example method for determining whether to generate radio configuration parameters for a UE in response to receiving a CN-to-BS message indicating that the UE has joined an MBS session, which can be implemented in a base station of FIG. 1A;

FIGS. 19-20 are flow diagrams of example methods for managing transmission of MBS, which can be implemented by a base station of FIG. 1A; and

FIG. 21 is a flow diagram of an example method for managing transmission of MBS, which can be implemented by a CN of FIG. 1A.

### DETAILED DESCRIPTION OF THE DRAWINGS

Generally speaking, a RAN and/or a CN implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QOS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

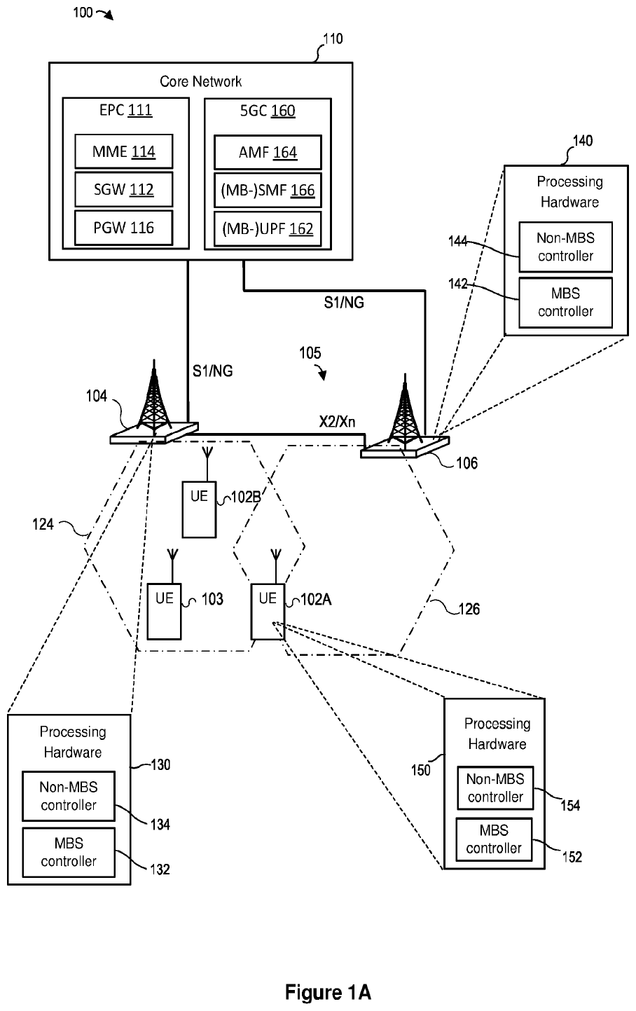

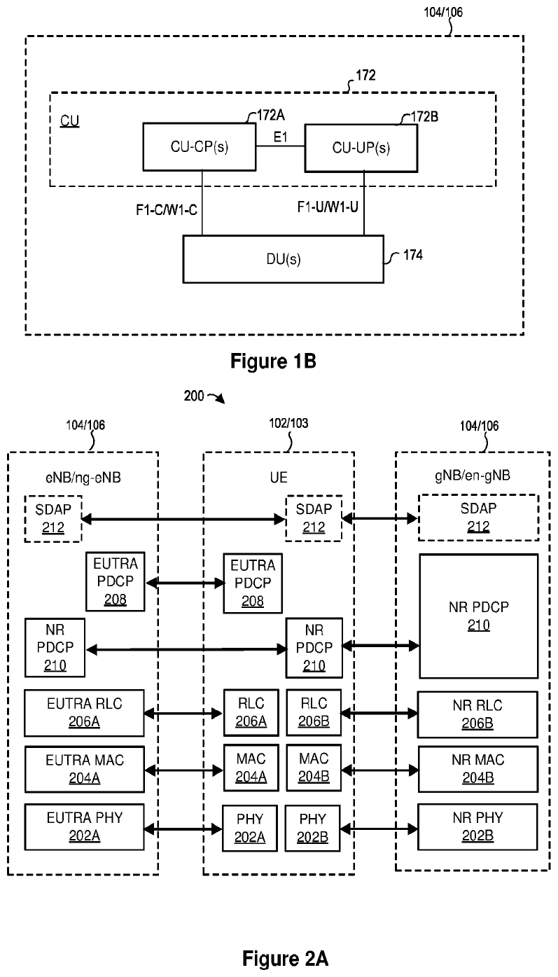

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-cNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-cNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B, 103A and 103B.

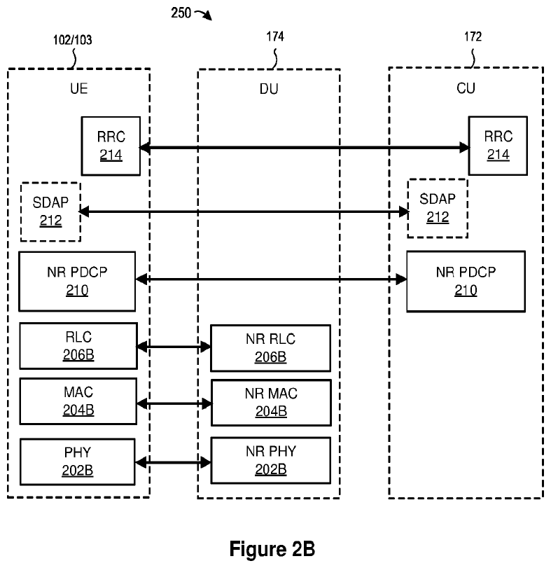

FIG. 2A illustrates, in a simplified manner, an example protocol stack 200 according to which a UE (e.g., UE 102A, 102B or 103) can communicate with an cNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts or multicasts MBS data packets via one or more MBS radio bearers (MRB(s)), and in turn the receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

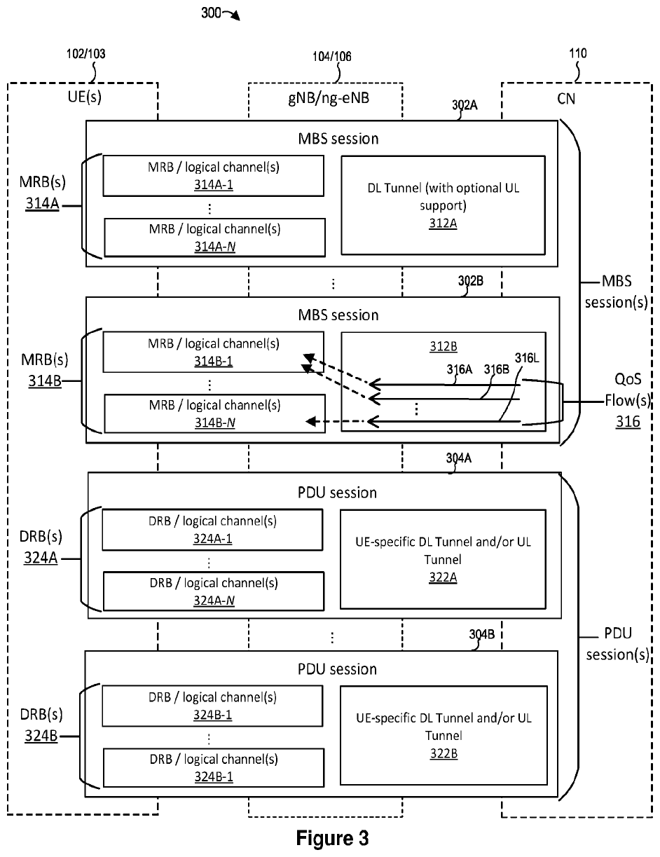

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2 . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B . . . 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2 . . . 324-N. Each of the DRBs 324A can correspond to a respective logical channel, such as a Dedicated Traffic Channel (DTCH).

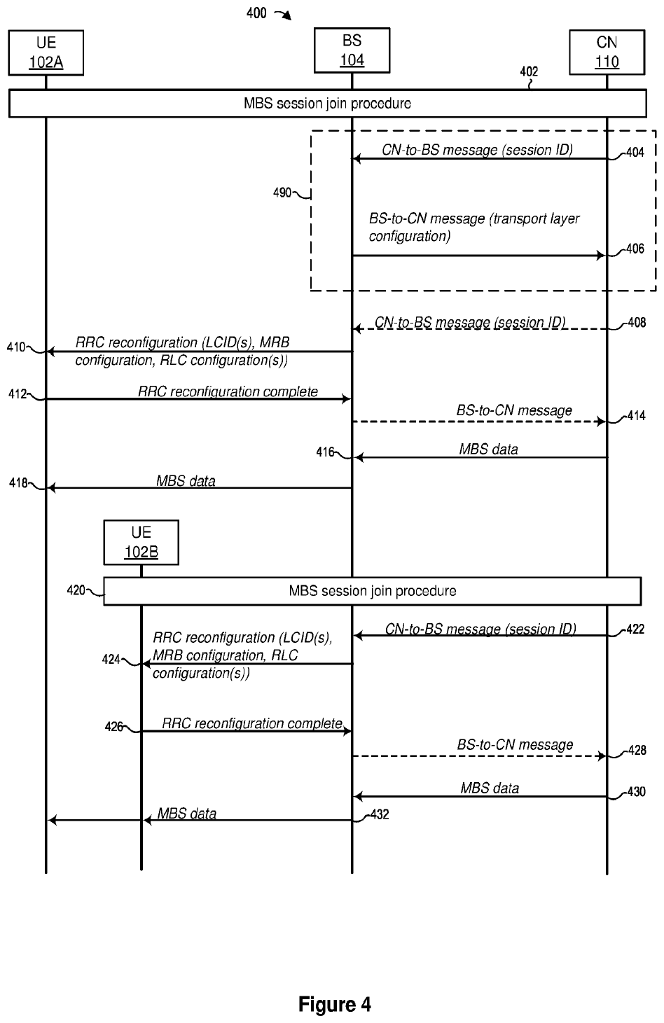

Next, FIG. 4 illustrates an example scenario 400 in which the base station 104 configures a common tunnel for MBS data in response to the CN requesting resources for an MBS session.

The UE 102A initially performs 402 an MBS session join procedure with the CN 110 via the base station 104 to join a certain MBS session. In some scenarios, the UE 102A subsequently performs additional one or more MBS join procedures, and event 402 accordingly is a first one of multiple MBS join procedures. Because the base station 104 configures a common DL tunnel for MBS traffic rather than a UE-specific tunnel, as discussed below, the procedures 402 and 490 can occur in either order. In other words, the base station 104 can configure a common DL tunnel before even a single UE joins the MBS session.

To perform the MBS session join procedure, the UE 102A in some implementations sends an MBS session join request message to the CN 110 via the base station 104. In response, the CN 110 can send an MBS session join response message to the UE 102A via the base station 104 to grant the UE 102A access to the first MBS session. In some implementations, the UE 102A can include an MBS session ID of the MBS session in the MBS session join request message. The CN 110 in some cases includes the MBS session ID in the MBS session join response message. In some implementations, the UE 102A can send an MBS session join complete message to the CN 110 via the base station 104 in response to the MBS session join response message.

The UE 102A in some cases performs additional MBS session join procedure(s) with the CN 110 via the RAN 105 (e.g., the base station 104 or base station 106) to join additional MBS session(s). For example, the UE 102A can perform a second MBS session join procedure with the CN 110 via the RAN 105 to join a second MBS session. Similar to event 402, the UE 102A in some implementations can send a second MBS session join request message to the CN 110 via the base station 104, and the CN 110 can respond with a second MBS session join response message to grant the UE 102A access to the second MBS session. In some implementations, the UE 102A can send a second MBS session join complete message to the CN 110 via the base station 104 in response to the second MBS session join response message. In some implementations, the UE 102A can include a second MBS session ID of the second MBS session in the second MBS session join request message. The CN 110 optionally includes the second MBS session ID in the second MBS session join response message. In some implementations, the UE 102A can include the first and second MBS session IDs in an MBS session join request message (e.g., the first MBS session join request message) to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102A can transmit to the CN 110 via the base station 104 a (first) UL container message including the MBS session join request message, the CN 110 can transmit to the UE 102A via the base station 104 a DL container message including the MBS session join response message, and the UE 102A can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent the container messages.

In some implementations, the UE 102A can perform a PDU session establishment procedure with the CN 110 via the base station 104 to establish a PDU session in order to perform the first MBS session join procedure and/or additional MBS session join procedure(s). During the PDU session establishment procedure, the UE 102A can communicate a PDU session ID of the PDU session with the CN 110 via the base station 104.

Before, during, or after the (first) MBS session join procedure (event 402), the CN 110 can send 404 a (first) CN-to-BS message including the first MBS session ID and/or the PDU session ID to the base station 104 to request the base station 104 to configure resources for the first MBS session. The CN 110 can additionally include quality of service (QOS) configuration(s) for the first MBS session. In response, the base station 104 can send 406 a (first) BS-to-CN message (e.g., MBS Session Resource Setup Response message) including a DL transport layer configuration to configure a common DL tunnel for the CN 110 to send MBS data to the base station 104. The DL transport layer configuration includes a transport layer address (e.g., an IP address and/or a TEID) to identify the common DL tunnel. The base station 104 can include the first MBS session ID and/or the PDU session ID in the first BS-to-CN message.

In some implementations, the CN-to-BS message of event 404 can be a generic NGAP message or a dedicated NGAP message defined specifically for requesting resources for an MBS session (e.g., MBS Session Resource Setup Request message). In some implementations, the BS-to-CN message of event 406 is a generic NGAP message or a dedicated NGAP message defined specifically to convey resources for an MBS session (e.g., MBS Session Resource Setup Response message). In such cases, the CN-to-BS message of event 404 and the BS-to-CN message of event 406 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5Q1), a priority level, packet delay budget, packet error rate, averaging window, and/or a maximum data burst volume. The CN 110 can specify different values of the QoS parameters for the QoS flows.

The events 404 and 406 are collectively referred to in FIG. 4A as an MBS session resource setup procedure 490.

In cases where the CN 110 grants the additional MBS session(s) for the UE 102A in the additional MBS session join procedure(s), the CN 110 can include the additional MBS session ID(s) and, optionally, QoS configuration(s) for the additional MBS session ID(s) in the first or second CN-to-BS message. In such cases, the base station 104 includes additional transport layer configuration(s) for the additional MBS session(s) to configure additional common DL tunnel(s) in the first or second BS-to-CN message. Each of the transport layer configuration(s) configures a particular common DL tunnel of the common DL tunnel(s) and can be associated to a particular MBS session of the additional MBS session(s). Alternatively, the CN 110 can perform additional MBS session resource setup procedure(s) with the base station 104 to obtain the additional transport layer configuration(s) from the base station 104, similar to the single-session MBS session resource setup procedure 490 shown in FIG. 4. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 can indicate, in the CN-to-BS message of event 404, a list of UEs joining the first MBS session. In other implementations, the CN 110 can send 408 to the base station 104 another, second CN-to-BS message indicating a list of UEs joining the first MBS session. The CN 110 can include the first MBS session ID and/or the PDU session ID in the second CN-to-BS message. The base station 104 can send 414 a second BS-to-CN message to the CN 110 in response to the second CN-to-BS message 408. In such cases, the second CN-to-BS message and the second BS-to-CN message can be non-UE-specific messages. For example, the list of UEs includes the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In other implementations, the CN 110 can send 408 to the base station 104 a second CN-to-BS message indicating that the UE 102A joins the first MBS session. The CN 110 can include the first MBS session ID and/or the PDU session ID in the second CN-to-BS message. The second CN-to-BS message can be a UE-specific message for the UE 102A. The base station 104 can send 414 a second BS-to-CN message to the CN 110 in response receiving 408 to the second CN-to-BS message. The base station 104 can include the first MBS session ID and/or the PDU session ID in the second BS-to-CN message. The CN 110 can include the MBS session join response message for the UE 102A in the second CN-to-BS message. The base station 104 can include the first CN UE interface ID and the first RAN UE interface ID in the second CN-to-BS message. Alternatively, the base station 104 can include the first UE ID in the second CN-to-BS message. In such implementations, the CN 110 can send (not shown) an additional CN-to-BS message to the base station 104 to indicate that (only) the UE 102B joins the first MBS session. The additional CN-to-BS message can be a UE-specific message for the UE 102B. The CN 110 can include the MBS session join response message for the UE 102B in the additional CN-to-BS message. The CN 110 can include the second CN UE interface ID and the second RAN UE interface ID in the additional CN-to-BS message. Alternatively, the CN 110 can include the second UE ID in the additional CN-to-BS message. The base station 104 can send (not shown) an additional BS-to-CN message to the CN 110 in response to the additional CN-to-BS message.

In some implementations, the second CN-to-BS message and BS-to-CN message can be a PDU Session Resource Modify Request message and a PDU Session Resource Modify Response message, respectively.

In some implementations, the base station 104 can include the DL transport layer configuration(s) in the second BS-to-CN message and/or the additional BS-to-CN message. In other words, the base station 104 can send the same DL transport layer configuration(s) in BS-to-CN messages in responses to CN-to-BS messages indicating multiple UEs joining the same MBS session. In such implementations, the CN 110 can blend the MBS resource setup procedure 490 and the second and/or additional CN-to-BS and BS-to-CN messages into a single procedure.

In some implementations, the base station 104 can perform the MBS resource setup procedure 490 with the CN 110 in response to receiving the second CN-to-BS message. In such implementations, the base station 104 transmits the first BS-to-CN message to the CN 110 in response to receiving the second CN-to-BS message. Then, the CN 110 sends the first CN-to-BS message to the base station 104 in response to the first BS-to-CN message. In such cases, the CN 110 may or may not include an MBS session ID (i.e., the first MBS session ID) in the first CN-to-BS message.

In cases where the base station 104 performs the MBS resource setup procedure 490 with the CN 110 to establish the common DL tunnel for the first MBS session, the base station 104 may refrain from including a DL transport layer configuration for the first MBS session in the second BS-to-CN message. In such cases, the CN 110 may refrain from including a UL transport layer configuration for the first MBS session in the second CN-to-BS message.

After performing 490 the MBS session resource setup procedure or receiving 408 the second CN-to-BS message, the base station 104 generates RRC reconfiguration message(s) (e.g., RRCReconfiguration message(s)) including configuration parameters for the UE 102A to receive MBS data of the first MBS session. The base station 104 then transmits 410 the RRC reconfiguration message(s) to the UE 102A. In response, the UE 102A transmits 412 an RRC reconfiguration complete message(s) (e.g., RRCReconfigurationComplete message(s)) to the base station 104. The base station 104 can send 414 the second BS-to-CN message to the CN 110 before or after receiving the RRC reconfiguration complete message(s).

After receiving 406 the first BS-to-CN message or receiving 414 the second BS-to-CN message, the CN 110 can send 416 MBS data to the base station 104, which in turn transmits (e.g., multicast or unicast) 418 the MBS data via the one or more logical channels to the UE 102A. The UE 102A receives 418 the MBS data via the one or more logical channels. For example, the base station 104 receives 416 an MBS data packet, generates a PDCP PDU including the MBS data packet, generates a MAC PDU including the logical channel ID and the PDCP PDU, and transmits 418 the MAC PDU to the UE 102A. The UE 102A receives 418 the MAC PDU, retrieves the PDCP PDU and the logical channel ID from the MAC PDU, identifies the PDCP PDU associated with the MRB and retrieves the MBS data packet from the PDCP PDU.

In some implementations, the configuration parameters can include one or more MRB configurations configuring one or more MRBs associated with the first MBS session. The configuration parameters can also include one or more RLC bearer configurations, each associated with a particular MRB. Each of the MRB configuration(s) can include an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the configuration parameters or the MRB configuration may include logical channel configuration (e.g., LogicalChannelConfig 1E) configuring configure the logical channel. In some implementations, the RLC bearer configuration may include the MRB ID.

In some implementations, the base station 104 can configure the MRB as a DL-only RB in the MRB configuration. For example, the base station 104 can refrain from including UL configuration parameters in the PDCP configuration within the MBR configuration to configure the MRB as a DL-only RB. The base station 104 can include only DL configuration parameters in the MRB configuration, e.g., as described above. In such cases, the base station 104 configures the UE 102A to not transmit UL PDCP data PDU via the MRB to the base station 104 by excluding the UL configuration parameters for the MRB in the PDCP configuration in the MBR configuration. In another example, the base station 104 refrains from including UL configuration parameters in the RLC bearer configuration. In such cases, the base station 104 configures the UE 102A not to transmit the control PDU(s) via the logical channel to the base station 104 by excluding the UL configuration parameters from the RLC bearer configuration.

In cases where the base station 104 includes UL configuration parameter(s) in the RLC bearer configuration, the UE 102A may transmit control PDU(s) (e.g., PDCP Control PDU(s) and/or RLC Control PDU(s)) via the logical channel to the base station 104 using the UL configuration parameter(s). For example, the base station 104 may configure the UE to receive MBS data with a (de) compression protocol (e.g., robust header compression (ROHC) protocol). In this case, when the base station 104 receives 416 an MBS data packet from the CN 110, the base station 104 compresses the MBS data packet with the compression protocol to obtain compressed MBS data packet(s) and transmits 418 a PDCP PDU including the compressed MBS data packet to the UE 102A. When the UE 102A receives the compressed MBS data packet(s), the UE 102A decompresses the compressed MBS data packet(s) with the (de) compression protocol to obtain the original MBS data packet. In such cases, the UE 102A may transmit a PDCP Control PDU including, a header compression protocol feedback (e.g., interspersed ROHC feedback) for operation of the header (de) compression protocol, via the logical channel to the base station 104.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the base station 104 has configured DRB(s) to the UE 102A for unicast data communication, the base station 104 in some implementations can set the MRB ID(s) to values different from DRB ID(s) of the DRB(s). In such cases, the UE 102A and the base station 104 can distinguish whether an RB is an MRB or a DRB in accordance an RB ID of the RB. In other implementations, the base station 104 can set one or more of the MRB ID(s) to values which can be the same as one or more of the DRB ID(s). In such cases, the UE 102A and the base station 104 can distinguish whether an RB is an MRB or a DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102A and base station 104 can determine an RB is a DRB if the UE 102A receives a DRB-ToAddMod IE configuring the RB, and determine an RB is an MRB if the UE 102A receives an MRB-ToAddMod IE configuring the RB.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters might or might not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the base station 104 can include the MBS session join response message in the RRC reconfiguration message the base station 104 transmits 410 to the UE 102A. The UE 102A can include the MBS session join complete message in the RRC reconfiguration complete message of event 412. Alternatively, the UE 102A can send a UL RRC message including the MBS session join complete message to the base station 104. The UL RRC message can be a ULInformationTransfer message or any suitable RRC message that can include a UL NAS PDU. The base station 104 can include the MBS session join complete message in the second BS-to-CN message. Alternatively, the base station 104 can send the CN 110 a BS-to-CN message (e.g., an UPLINK NAS TRANSPORT message) including the MBS session join complete r message to the CN 110.

In other implementations, the base station 104 transmits a DL RRC message that includes the MBS session join response message to the UE 102A. The DL RRC message can be a DLInformation Transfer message, another RRC reconfiguration message, or any suitable RRC message that can include a DL NAS PDU. The UE 102A can send a UL RRC message including the MBS session join complete message to the base station 104. The UL RRC message can be a ULInformationTransfer message, another RRC reconfiguration complete message or any suitable RRC message that can include a UL NAS PDU.

With continued reference to FIG. 4, the UE 102B can perform 420 an MBS session join procedure similar to the procedure 402 discussed above. The UE 102B can perform a PDU session establishment procedure with the CN 110 via the base station 104 as described above. The UE 102B can communicate a PDU session ID with the CN 110 in the PDU session establishment procedure. The UE 102B can join the same MBS session as the UE 102A by sending an MBS session join request and specifying the same MBS session ID. In this example scenario, the UE 102B joins the MBS session after the base station 104 has started transmitting 418 MBS data packets to the UE 102A. The CN 110 transmits 422, to the base station 104, a CN-to-BS message including the MBS session ID and/or the PDU session ID in order to indicate that the UE 102B should start receiving MBS data for an MBS session corresponding to the MBS session ID. In some implementations, the PDU session IDs of the UE 102A and UE 102B can be the same (value). In other implementations, the PDU session IDs of the UE 102A and UE 102B can be the different (values).

The base station 104 or CN 110 determines that a DL tunnel for the MBS session identified in the event 422 already exists, and that there is no need to perform the procedure 490. The base station 104 transmits 424 an RRC reconfiguration message to the UE 102B to configure the UE 102B to receive the MBS traffic. The RRC reconfiguration message can include the same LCID (value), MRB configuration, and RLC bearer configuration as the event 410, when the UEs 102A and 102B operate in the same cell. When the UEs 102A and 102B operate in different cells, the RRC reconfiguration message can have a different, G-RNTI, LCID and/or RLC bearer configuration, for example. The RRC reconfiguration message can include the same MRB configuration as the event 410, when the UEs 102A and 102B operate in different cells. As illustrated in FIG. 3, the base station 104 can map data packets arriving via the common DL tunnel to one or more MRBs, each corresponding to a respective logical channel.

The UE 102B transmits 426 an RRC reconfiguration complete message(s) (e.g., RRCReconfigurationComplete message(s)) to the base station 104 in response to the RRC reconfiguration message(s) of event 424. Before or after receiving 426 the RRC reconfiguration complete message(s), the base station 104 in some cases sends 428 another BS-to-CN message to the CN 110, generally similar to the event 414. The BS-to-CN message can indicate an updated list of UEs associated with the MBS session specified in the event 422, for example. After the UE 102B has joined 420 the MBS session and obtained 424 the necessary RRC configuration, the base station 104 continues to receive 430 MBS data via the common DL tunnel. In some implementations, the base station 104 transmits 432 the MBS data to the UE 102A and UE 102B via multicast. The UE 102A and UE 102B can receive 432 MBS data similar to event 418. Alternatively, the base station 104 can transmit the MBS data to the UE 102A and UE 102B separately via unicast.

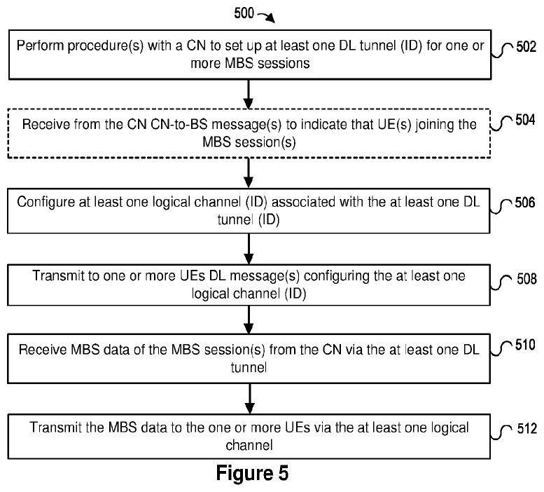

Next, several example scenarios which devices illustrated in FIGS. 1A and 1B can implement are discussed with reference to FIGS. 5-21. Each of these methods can be implemented as a set of instructions stored on a non-transitory computer-readable medium and executable by one or more processors.

Referring first to FIG. 5, a base station such as the base station 104 can implement a method 500 to configure a logical channel associated with a DL tunnel, and then transmit MBS data to one or more UEs via the logical channel. The method 500 begins at block 502, where the base station configures a common DL tunnel for one or more MBS sessions (see, e.g., events 404, 406, 408, 414, 422, 428). At block 504, the base station receives a CN-to-BS message indicating that a certain UE is joining one or more MBS sessions (see, e.g., events 404, 408, and 422). Execution of block 504 can occur prior to, substantially at the same time as, or subsequently to block 502, and the method 500 can include any suitable number of instances of block 504. Moreover, a CN-to-BS message can include both a request to configure a common DL channel for MBS traffic and an indication of one or more UEs joining the MBS session.

Next, at block 506, the base station configures one or more logical channels corresponding to the DL tunnel and, at block 508, transmits the logical channel configuration to the one or more UEs that joined the MBS session (see, e.g., events 410 and 424). At block 510, the base station 104 receives MBS data from the CN via the common DL tunnel (see, e.g., events 416 and 430). Then, at block 512, the base station transmits the MBS data via the one or more logical channels (i.e., using the logical channel ID(s)) (see, e.g., events 418 and 432). The logical channels can correspond to MRBs as illustrated in FIG. 3, for example.

More generally, the base station at blocks 508-512 can receive data packets for one or more MBS sessions and map the data packets onto multiple logical channels and the corresponding MRBs. Thus, the UE 102A of FIG. 1A can join multiple MBS sessions (e.g., two sports broadcasts occurring at the same time), and the base station can receive data packets for different MBS sessions via different DL tunnels and then transmit data packets for different MBS sessions using different logical channels.

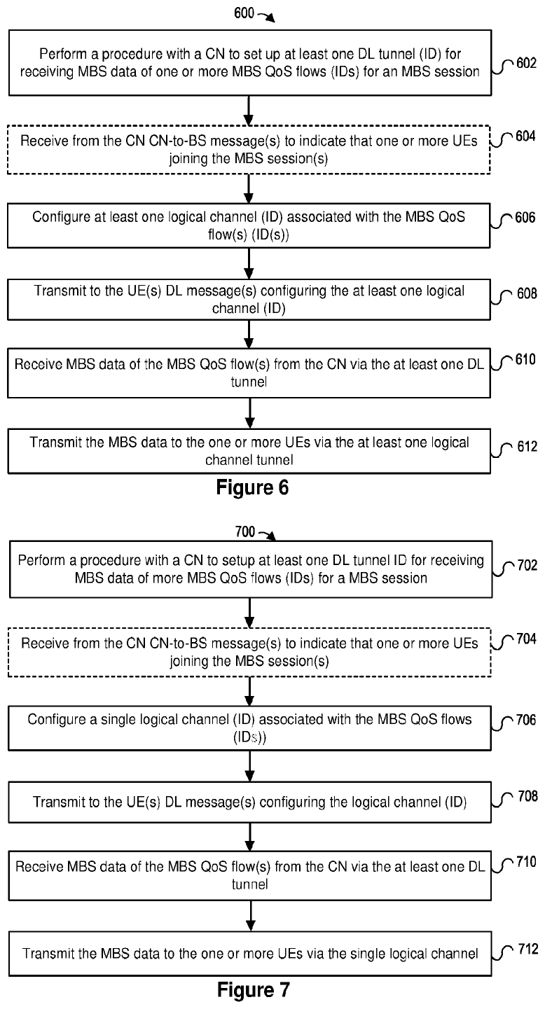

FIG. 6 illustrates an example method 600 for configuring and using a logical channel associated with a certain MBS QoS flow for an MBS session, and transmitting MBS data of the MBS QoS flow to one or more UEs via the logical channel, which also can be implemented in the base station 104 or another suitable base station. At block 602, the base station configures a common DL tunnel for an MBS session including one or more MBS QoS flows (see, e.g., events 404, 406, 408, 414, 422, 428). The data packets for each QoS flow can include a respective flow ID.

At block 604, the base station receives a CN-to-BS message indicating that a certain UE is joining one or more MBS sessions (see, e.g., events 404, 408, and 422), similar to block 504 discussed above. Next, at block 606, the base station configures one or more logical channels corresponding to the respective QoS flows. As illustrated in FIG. 3, each QoS flow can correspond to a single respective logical channel, or multiple QoS flows can correspond to the same logical channel.

Next, at block 608, the base station transmits the logical channel configuration to the one or more UEs that joined the MBS session (see, e.g., events 410 and 424). At block 610, the base station 104 receives MBS data associated with one or more QoS flows from the CN via one or more common DL tunnels (see, e.g., events 416 and 430). Then, at block 612, the base station transmits the MBS data via the one or more logical channels (i.e., using the logical channel ID(s)) (see, e.g., events 418 and 432).

For further clarity, FIG. 7 illustrates an example method 700 in a base station for configuring a common logical channel associated with multiple MBS QOS flows for an MBS session, and transmitting MBS data of the MBS QoS flows to one or more UEs via the logical channel. Blocks 702 and 704 are similar to blocks 602 and 604, respectively. At block 706, the base station configures a single logical channel for multiple QoS flows (scc FIG. 3). Blocks 708 and 710 are similar to blocks 608 and 610, respectively. At block 712, the base station transmits MBS data packets associated with multiple QoS flows over the same common logical channel (i.e., using the same logical channel ID), to the corresponding UEs.

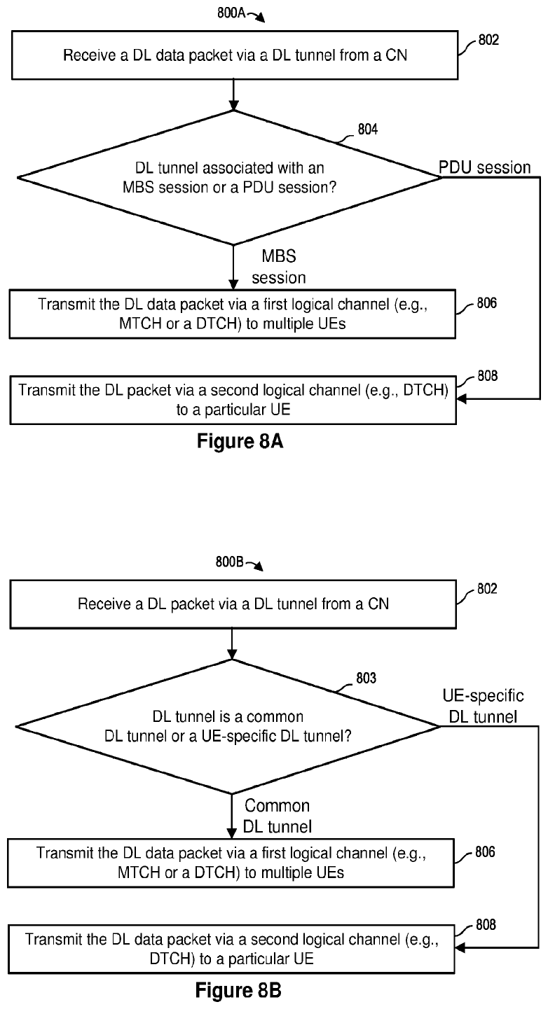

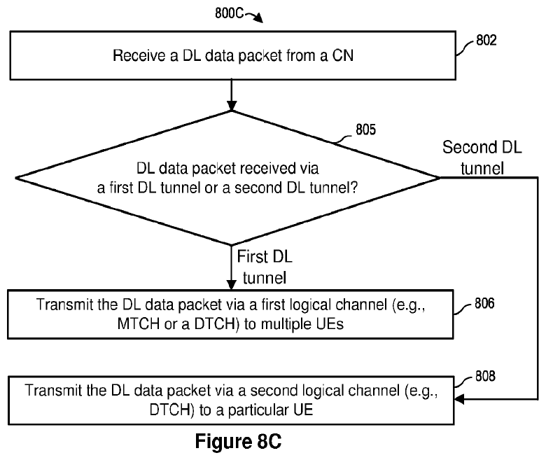

Now referring to FIG. 8A, a base station such as the base station 104 can implement an example method 800A to select logical channel for transmitting a data packet to a UE based on whether the data packet was received via a DL tunnel associated with an MBS session or a PDU session.

More specifically, at block 802, the base station receives a data packet from a CN (e.g., the CN 110) via a certain DL tunnel (see, e.g., events 416, 430). The base station can determine to which tunnel a data packet corresponds based on the IP address and the TEID or other suitable transport-layer information included in the header of the packet. At block 804, the base station determines whether the DL tunnel is associated with an MBS session or a PDU session set up for unicast transmission of data to a particular UE. To this end, the base station can maintain a table storing an indication of a session type (MBS, PDU, etc.) for each active DL tunnel. When the base station determines that the DL tunnel is associated with an MBS session, the flow proceeds to block 806, where the base station transmits the DL data packet via the corresponding logical channel to multiple UEs (see, e.g., events 418 and 432). The logical channel can be an MTCH or a DTCH associated with an MRB, for example. However, when the base station determines at block 804 that the DL tunnel is associated with a PDU session, the flow proceeds to block 808, where the base station transmits the DL data packet via the corresponding logical channel to a particular (singular) UE. The logical channel can be a DTCH associated with a DRB, for example.

FIG. 8B illustrates an example method 800B similar to method 800A, except that method 800B includes block 803 instead of block 804. At block 803, the base station determines whether the DL tunnel is a shared (or “common”) DL tunnel or a UE-specific DL tunnel. To this end, the base station can maintain a table storing an indication of UEs or RNTIs mapped to each active DL tunnel. More specifically, when the table indicates that a DL tunnel is mapped to a G-RNTI, the base station can determine that the DL tunnel is a common DL tunnel. When the table indicates that a DL tunnel is mapped to one or more C-RNTIs or other UE-specific RNTIs, the base station can determine that the DL tunnel is a UE-specific DL tunnel. The method 800B proceeds to block 806 when the DL tunnel is common, and to block 808 when the DL tunnel is UE-specific.

FIG. 8C illustrates an example method 800C similar to methods 800A and 800B, except that method 800B includes block 805 instead of block 803 or 804. At block 805, the base station determines whether the DL tunnel via which a packet arrived is a certain (first) tunnel configured for transmission of data to multiple UEs or another certain (second) tunnel configured for transmission of data to a particular UE. The base station according to this method can rely on DL tunnel information (e.g., transport layer address and/or the TEID value) and an indication (e.g., RNTIs) stored in the memory of the base station. To this end, the base station can maintain a table storing an indication of UEs or RNTIs mapped to DL tunnel information of each active DL tunnel. When the base station identifies the tunnel as the first tunnel, the method 800C proceeds to block 806; the method 800C otherwise proceeds to block 808.

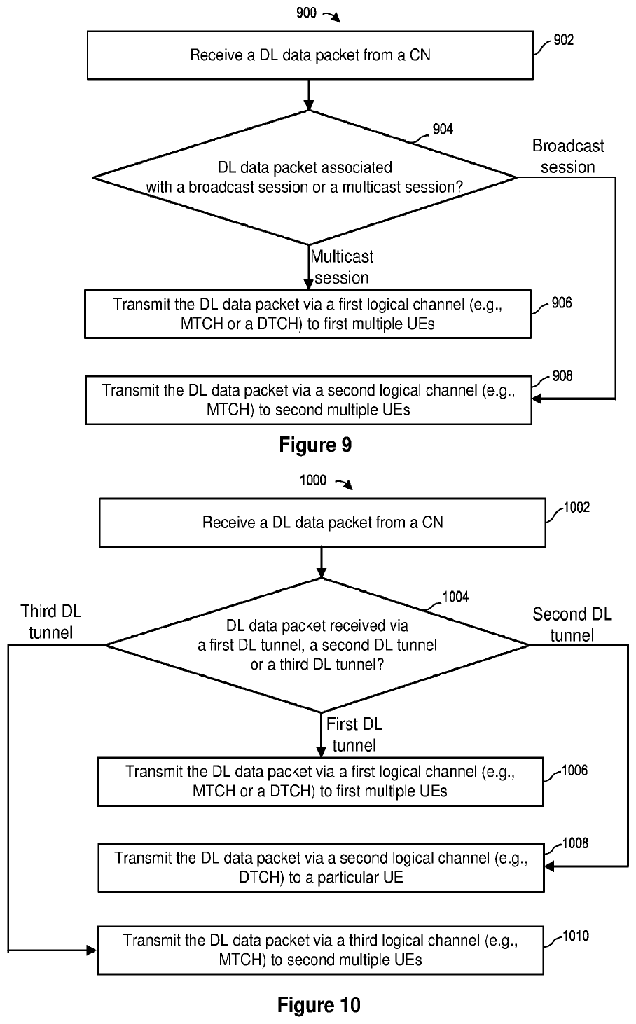

Next, FIG. 9 illustrates another example method 900 for determining which logical channel to use for transmission of a data packet to a UE, which can be implemented in a suitable base station. At block 902, the base station receives a DL data packet from a CN (e.g., the CN 110) (see, e.g., events 416, 430). At block 904, the base station determines whether the DL data packet is associated with a broadcast session or a multicast session. The base station can make this determination based on header(s) of a tunnel packet including the data packet, based on the type of DL tunnel via which the data packet arrived (e.g., when one DL tunnel is configured for a broadcast MBS session and another DL tunnel is configured for a multicast MBS session), based on the QoS flow ID of the data packet (e.g., when one QoS flow is configured for broadcast packets and another QoS flow is configured for multicast packets, of the same MBS session or different MBS sessions), or in any other suitable manner. In some implementations, the header(s) can include an IP address and/or an TEID of the DL tunnel. For example, the header(s) includes an IP header and an GTP header including the IP address and the TEID, respectively. In some further implementations, the header(s) can include the QoS flow ID.

When the base station determines that the DL data packet is associated with a multicast session, the flow proceeds to block 906, where the base station transmits the DL data packet via a certain (first) logical channel to a certain (first) set of UEs (see, e.g., events 418 and 432). The logical channel can be an MTCH or a DTCH associated with an MRB, for example. When the base station determines that the DL data packet is associated with a broadcast session, the flow proceeds to block 908, where the base station transmits the DL data packet via another (second) logical channel to another (second) set of UEs. The logical channel can be an MTCH, for example.

Now referring to FIG. 10, a base station can implement an example method 1000 to use different logical channels for broadcast, multicast, and unicast services. At block 1002, the base station receives a data packet from a CN via one of DL tunnels (e.g., the CN 110) (see, e.g., events 416, 430). The base station can determine to which tunnel a data packet corresponds based on the IP address and the TEID or other suitable transport-layer information included in header(s) of a tunnel packet including the data packet.

At block 1004, the base station determines whether the data packet arrived via a first DL tunnel, a second DL tunnel, or a third DL tunnel. The base station in this example previously configured the first DL tunnel for multicast traffic to a certain (first) set of UEs, the second DL tunnel for unicast traffic for a particular UE, and the third DL tunnel for broadcast traffic for a certain (second) set of UEs. The flow proceeds to block 1006, 1008, or 1010 when the base station determines that the data packet arrived via the first, second, or third DL tunnel, respectively.

At block 1006, the base station transmits the DL data packet via the corresponding (first) logical channel to the first set of UEs (see, e.g., events 418 and 432). The first logical channel can be an MTCH or a DTCH associated with an MRB, for example. At block 1008, the base station transmits the DL data packet via the corresponding (second) logical channel to a particular (singular) UE. The second logical channel can be a DTCH associated with a DRB, for example. At block 1010, the base station transmits the DL data packet via a third logical channel to the second set of UEs. The third logical channel can be an MTCH, for example.

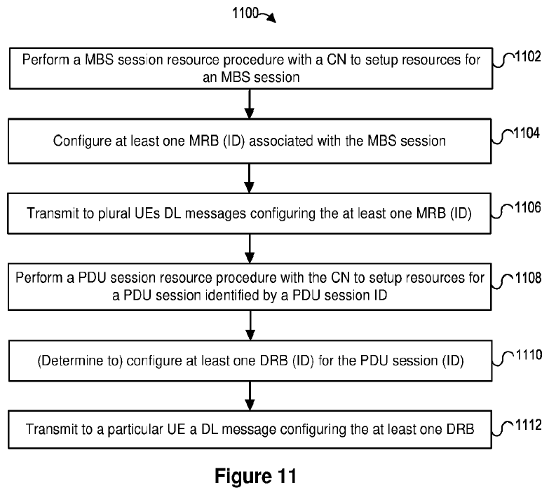

FIG. 11 illustrates an example method 1100 for configuring an MRB and a DRB for an MBS session and a PDU session, respectively, at a base station. At block 1102, the base station configures resources associated with the CN-to-BS link for an MBS session (see, e.g., events 404, 406, 408, 414, 422, 428). Next, at block 1104, the base station configures one or more MRBs for the MBS session. At block 1106, the base station transmits the MRB configuration to the multiple UEs that joined the MBS session (see, e.g., events 410 and 424).

Next, at block 1108, the base station performs a procedure to configure a PDU session with the CN. Referring back to FIG. 3, the base station and the CN can establish a PDU session identifiable by a PDU session ID to support unicast traffic between a particular UE and the CN. At block 1110, the base station configures at least one DRB for the PDU session. Then, at block 1112, the base station transmits the DRB configuration to the corresponding UE.

In some implementation, the base station uses different ranges of values for IDs assigned to MRBs and DRBs. Thus, the radio bearer ID can indicate whether the radio bearer operates as an MRB for multicast and/or broadcast, or as a DRB for unicast. In another implementation, the base station can assign the same ID to an MRB and a DRB, and UEs can rely on other parameters (e.g., RRC configuration parameters) to distinguish between MRBs and DRBs.

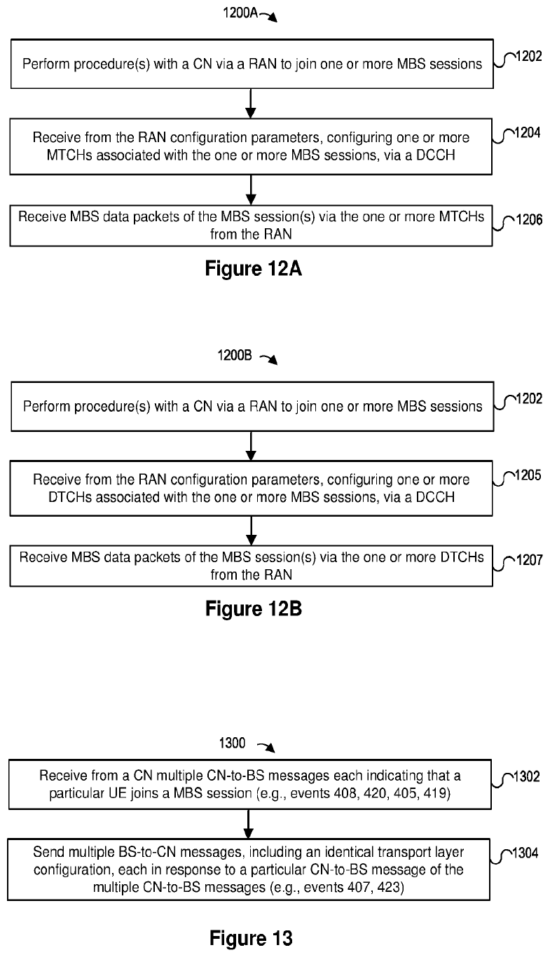

Next, FIGS. 12A-12B illustrate example methods which a UE (e.g., the UE 102A, the UE 102B, the UE 103) can implement to receive MBS data packets of an MBS session via a multicast traffic channel (MTCH) or a dedicated traffic channel (DTCH).

The method 1200A of FIG. 12A begins at block 1202, where the UE performs one or more MBS join procedures (see, e.g., events 402 and 420) to join one or more MBS sessions. At block 1104, the UE receives, via a DCCH, configuration for one or more MTCHs the base station configured for the MBS session(s) (see, e.g., events 410 and 424). At block 1206, the UE receives MBS data packets via the one or more MTCHs, from the base station (see, e.g., events 418 and 432). The UE in this case can establish a PDU session to join the MBS session(s).

The method of 1200B of FIG. 12B is similar to the method 1200A, but here the flow proceeds from block 1202 to block 1205, where the UE receives, from a base station via a DCCH, a configuration for one or more DTCHs associated with the one or more MBS sessions. At block 1207, the UE receives MBS data packets via the one or more DTCHs. The UE in this case can establish a PDU session to join the MBS session(s).

Referring to FIGS. 12A and 12B, a UE according to different implementations or scenarios can receive MBS data via a multicast/broadcast channel or a UE-specific unicast channel, and use an MBS session configuration or a PDU session configuration for MBS data packets.

Next, FIG. 13 illustrates an example method 1300 for using a UE-specific procedures to establish a common DL tunnel, which can be implemented in a suitable base station. At block 1302, the base station receives from the CN multiple CN-to-BS messages, each indicating a request to join an MBS session from a respective UE (see, e.g., events 402, 420). At block 1304, the base station sends multiple BS-to-CN messages, each including the same transport layer configuration, such as the IP address and the TEID (see, e.g., event 406). Thus, the base station can effectively add new UEs to a previously established DL tunnel, to indicate to the CN that the CN should use the same DL tunnel for MBS traffic addressed to multiple UEs operating in a cell of the base station.

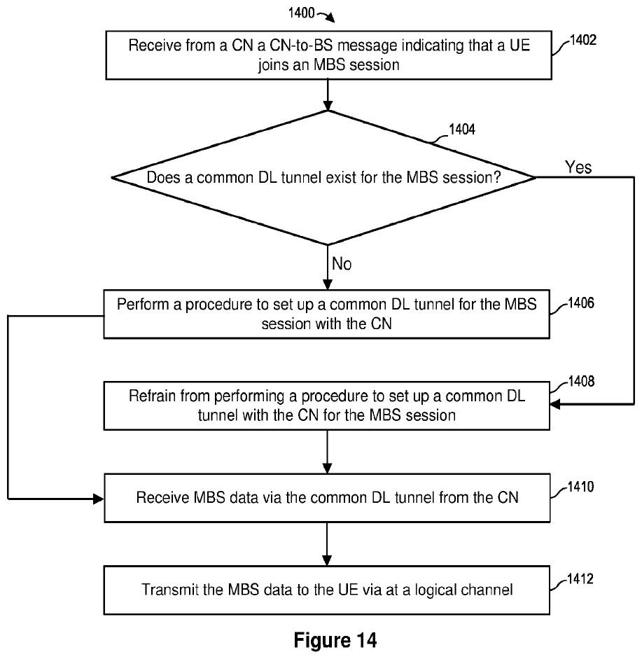

FIG. 14 is a flow diagram of an example method 1400 for determining, at a base station, whether to configure a common DL tunnel for an MBS session. The method 1400 begins at block 1402, where the base station receives, from the CN, a CN-to-BS message indicating that a UE has joined an MBS session (see, e.g., events 408 and 422). At block 1404, the base station determines whether a common DL tunnel exists for the MBS session. Upon determining that a common DL tunnel does not yet exist, the flow proceeds to block 1406, and the base station performs a procedure for setting up a common DL tunnel for the MBS session, with the CN (see, e.g., events 414 and 428). As discussed above, the base station can provide a particular transport configuration, such as an IP address and a TEID, in the procedure to configure the DL tunnel, and can correspond to one QoS flow or multiple QoS flows. Otherwise, when the base station determines that a common DL tunnel already exists, the flow proceeds to block 1408, and the base station does not perform a procedure for setting up a common DL tunnel.

The flow proceeds to block 1410 from block 1406 as well as from block 1408. At block 1410, the base station receives MBS data packets via the common DL tunnel (see, e.g., events 416 and 430). The base station transmits the MBS data packets to the UE via a logical channel (see, e.g., events 418 and 432), which can be an MTCH associated with an MRB for example.

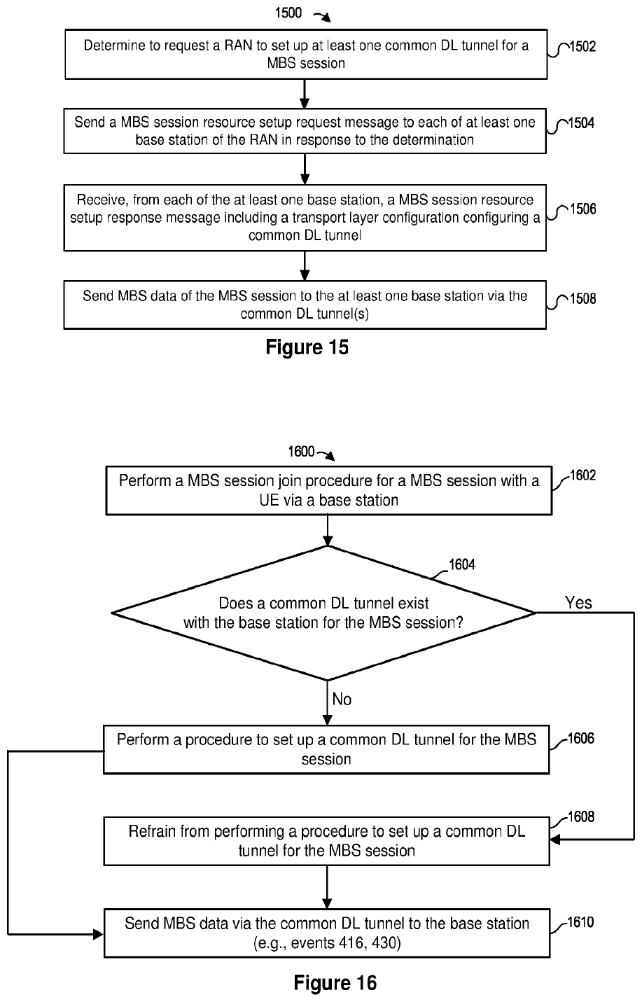

Now referring to FIG. 15, a CN (such as the CN 110) can implement an example method 1500 for establishing a common DL tunnel for an MBS session. At block 1502, the CN determines that it should request the RAN (e.g., the RAN 105) to set up at least one common DL tunnel for an MBS session. At block 1504, the CN sends a message requesting a configuration for an MBS session, to each base station in the RAN or to each in the relevant set of base stations (see, e.g., event 404). Next, at block 1506, the CN receives a transport-layer configuration for the MBS session from each of the base stations, where each transport-layer configuration specifies a common DL tunnel (see, e.g., event 406). At block 1508, the CN sends MBS data associated with the MBS session to one or more of the base stations via the respective common DL tunnels (see, e.g., event 416).

FIG. 16 illustrates example method 1600 for determining whether to configure a DL tunnel for an MBS session in response to a UE joining the MBS session, which also can be implemented in a CN. At block 1602, the CN performs an MBS join procedures with a UE, via a base station (see, e.g., event 402 or 420). The CN determines, at block 1604, whether a common DL tunnel exists for the MBS session. When a common DL tunnel does not yet exist, the flow proceeds to block 1606, and the CN performs a procedure for setting up a common DL tunnel for the MBS session, with the base station (see, e.g., events 404 and 406). Otherwise, when the CN determines that a common DL tunnel already exists, the flow proceeds to block 1608, and the CN does not perform a procedure for setting up a common DL tunnel. The flow proceeds to block 1610 from block 1606 as well as from block 1608. At block 1610, the CN sends MBS data packets to the base station via the common DL tunnel (see, e.g., events 416 and 430).

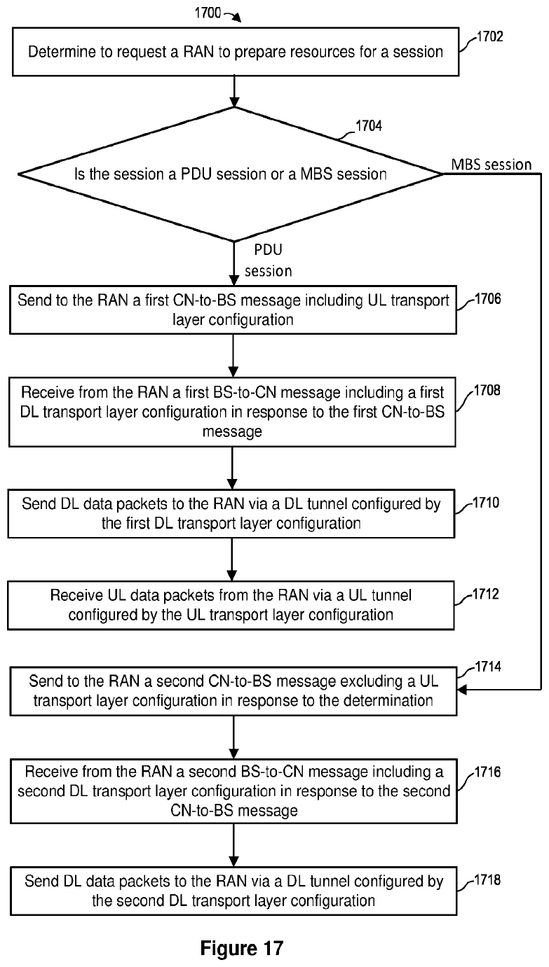

FIG. 17 illustrates an example method 1700 for determining whether to include an uplink (UL) transport layer configuration in a CN-to-BS message, which also can be implemented in a CN. According to this method, the CN can determine whether an UL tunnel is required at all and, in the case of MBS, choose to omit UL configuration.

At block 1702, the CN determines that is should request that the RAN prepare resources for a certain data session. When the CN determines, at block 1704, that the session is a PDU session, the flow proceeds to block 1706. Otherwise, when the CN determines that the session is an MBS session, the flow proceeds to block 1714. In some implementations, the “PDU session” can be changed to “non-MBS session”.

At block 1706, the CN sends a CN-to-BS message including UL transport layer configuration. Next, at block 1708, the CN receives from the RAN a BS-to-CN message including DL transport-layer configuration. At block 1710, the CN sends DL data packets to the RAN via a DL tunnel corresponding to the transport-layer configuration, and at block 1712, the CN receives UL data packets from the RAN via an UL tunnel corresponding to the transport-layer configuration. Thus, the CN both transmits and receives data via respective tunnels when the session is a PDU session.

On the other hand, at block 1714, the CN sends a CN-to-BS message excluding UL transport layer configuration. At block 1716, the CN receives from the RAN a BS-to-CN message including DL transport-layer configuration. At block 1718, the CN sends DL data packets to the RAN via a DL tunnel corresponding to the transport-layer configuration. The CN in this case does not provide a mechanism for receiving UL data for an MBS session.

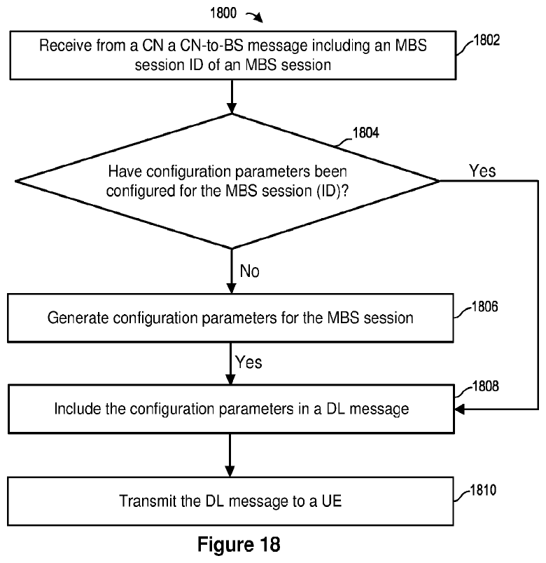

FIG. 18 is a flow diagram of an example method 1800 which a base station can implement determine whether to generate radio configuration parameters for a UE in response to receiving a CN-to-BS message indicating that the UE has joined an MBS session.

At block 1802, the base station receives, from a CN, a CN-to-BS message including an MBS session ID for a certain MBS session (see, e.g., events 404, 422). The base station determines at block 1804 whether configuration parameters for the identified MBS session already exists and, if so, the flow proceeds to block 1808 (see, e.g., event 428). Otherwise, the flow proceeds to block 1806, where the base station generates configuration parameters for the MBS session (see, e.g., 406). In some implementations, these configuration parameters can include a transport layer configuration of a DL tunnel between the CN and the BS. In other implementations, the configuration parameters can include G-RNTI, a logical channel ID, a RLC bearer configuration and/or a MRB configuration for the radio interface between the base station and the UE, for example. At block 1808, the base station includes the relevant configuration parameters, such as the G-RNTI, logical channel ID, RLC bearer configuration and/or MRB configuration, in a DL message and, at block 1810, transmits the DL message to the UE.

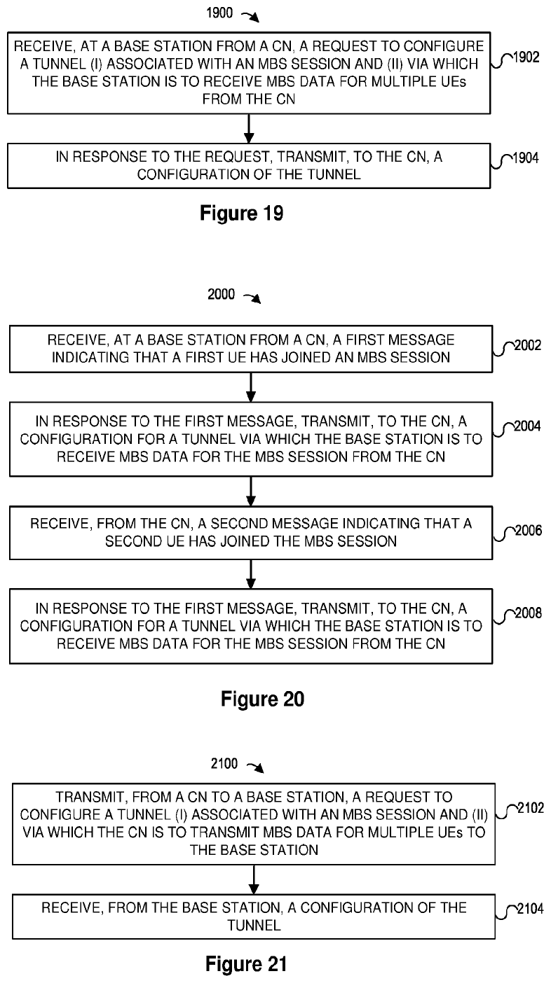

Next, FIGS. 19-20 illustrate several example methods for managing transmission of MBS, which can be implemented in a base station.

Referring first to the method 1900 of FIG. 19, the base station at block 1902 receives, from a CN, a request to configure a tunnel (i) associated with an MBS session and (ii) via which the base station is to receive MBS data for multiple UEs (see, e.g., events 404, 422, blocks 502, 602, 702). At block 1904, the base station transmits, to the CN, a configuration of the tunnel (see, e.g., events 406, 428, block 502, 602, 702).

Referring to FIG. 20, a method 2000 begins at block 2002, where a base station receives, from a CN, a first message indicating that a first UE has joined an MBS session. At block 2004, the base station transmits, in response to the first message and to the CN, a configuration for a tunnel via which the base station is to receive MBS data for the MBS session. At block 2006, the base station receives, from the CN, a second message indicating that a second UE has joined the MBS session. At block 2008, the base station transmits, in response to the first message and to the CN, a configuration for a tunnel via which the base station is to receive MBS data for the MBS session.

Finally, FIG. 21 illustrates an example method 2100 for managing transmission of MBS, which can be implemented in a CN. At block 2102, the CN transmits, to a base station, a request to configure a tunnel (i) associated with an MBS session and (ii) via which the CN is to transmit MBS data for multiple UEs to the base station (see, e.g., event 404). At block 2104, the CN receives, from the base station, a configuration of the tunnel (see, e.g., event 406).

The following list of examples reflects a variety of the embodiments explicitly contemplated by the present disclosure:

Example 1. A method in a base station for managing transmission of multicast and/or broadcast services (MBS), the method comprising: receiving, by processing hardware from a core network (CN), a request to configure a common tunnel associated with an MBS session, via which the base station is to receive MBS data, from the CN, for wireless transmission to multiple user equipment (UEs); and in response to the request, transmitting, by the processing hardware to the CN, a configuration of the common tunnel.

Example 2. The method of example 1, further comprising: configuring, by the processing hardware, a logical channel associated a radio interface and corresponding to the common tunnel; receiving, by the processing hardware, the MBS data from the CN via the common tunnel; and transmitting, by the processing hardware, the MBS data to the multiple UEs via the logical channel over the radio interface.

Example 3. The method of example 2, wherein: configuring the logical channel includes configuring the logical channel for multiple quality of service (QOS) flows for the MBS session; receiving the MBS data includes receiving the MBS data associated with the multiple QoS flows; and transmitting the MBS data includes transmitting the MBS data associated with the multiple QoS flows via the logical channel.

Example 4. The method of example 2, wherein: the configuring includes configuring a plurality of logical channels; the method further comprising: mapping a multiplicity of QoS flows in the MBS data to the plurality of logical channels.

Example 5. The method of example 2, further comprising: configuring, by the processing hardware, a multicast radio bearer (MRB) for transmitting data received via the common tunnel; and wherein transmitting the MBS data includes using the MRB.

Example 6. The method of example 5, wherein the configuring includes: associating the MRB with a logical channel associated with the common tunnel.

Example 7. The method of example 1, further comprising: receiving, by the processing hardware, the MBS data via the common tunnel; and in response to determining that the common tunnel is associated with the MBS session, selecting a logical channel via which to transmit the MBS data.

Example 8. The method of example 1, further comprising: receiving, by the processing hardware, the MBS data via the common tunnel; and in response to determining that the common tunnel is configured for receiving the MBS data for multiple UEs, selecting a logical channel via which to transmit the MBS data.

Example 9. The method of example 1, further comprising: based on at least one of an Internet Protocol (IP) address or a tunnel identifier of a received data packet, determining whether the data packet arrived via the common tunnel associated with the MBS session or a tunnel configured for a particular UE; and selecting a logical channel via which to transmit the data packet based on the determining.

Example 10. The method of example 1, further comprising: receiving, by the processing hardware, the MBS data via the common tunnel; and based on determining whether the MBS data is broadcast data or multicast data, selecting a logical channel via which to transmit the MBS data.

Example 11. The method of any one of examples 7-10, wherein the selecting includes selecting at least one of a multicast traffic channel or a dedicated traffic channel.

Example 12. The method of example 1, further comprising: configuring, by the processing hardware, a multicast radio bearer (MRB) for the MBS session; assigning, by the processing hardware, a first identifier to the MRB; configuring, by the processing hardware, a data radio bearer (DRB) for a particular UE; assigning, by the processing hardware, a second identifier to the DRB.

Example 13. The method of example 12, wherein assigning the first identifier and assigning the second identifier include selecting the first identifier and the second identifier from an overlapping number space.

Example 14. The method of example 12, wherein assigning the first identifier and assigning the second identifier include selecting the first identifier and the second identifier from non-overlapping number spaces.

Example 15. The method of example 1, wherein the configuration includes a transport layer address.

Example 16. The method of example 1 or 15, wherein the configuration includes a common tunnel identifier.

Example 17. The method of any one of examples 1 or 15-16, wherein the request includes an identifier of the MBS session.

Example 18. The method of any one of examples 1 or 15-17, wherein the request includes a quality of service configuration for the MBS session.

Example 19. The method of any one of examples 1 or 15-18, wherein the request identifies one or more QoS flows for the MBS session.

Example 20. The method of example 1, further comprising: receiving, by the processing hardware, an MBS data packet from the CN via the common tunnel; and transmitting, by the processing hardware, the MBS data packet to a first UE and a second UE.

Example 21. The method of example 1, further comprising: receiving, by the processing hardware from the CN, a first message indicating that a first UE has joined an MBS session; generating, by the processing hardware, configuration parameters for receiving the MBS data from the base station; transmitting, by the processing hardware to the first UE, the configuration parameters; receiving, by the processing hardware, from the CN, a second message indicating that a second UE has joined the MBS session; and transmitting, by the processing hardware to the second UE, the configuration parameters.

Example 22. A method in a base station for managing transmission of multicast and/or broadcast services (MBS), the method comprising: receiving, by processing hardware from a core network (CN), a first message indicating that a first user equipment (UE) has joined an MBS session; and in response to the first message, transmitting, by the processing hardware to the CN, a configuration for a tunnel via which the base station is to receive, from the CN, MBS data for the MBS session; receiving, by the processing hardware from the CN, a second message indicating that a second UE has joined the MBS session; and in response to the second message, transmitting, by the processing hardware to the CN, the configuration.

Example 23. The method of example 21, further comprising: receiving, by the processing hardware from the CN, the MBS data via the tunnel; and transmitting, by the processing hardware, the MBS data to the first UE and the second UE using an RRC configuration for the MBS session.

Example 24. A base station including processing hardware and configured to implement a method according to any one of the preceding examples.

Example 25. A method in a core network (CN) for managing transmission of multicast and/or broadcast services (MBS), the method comprising: transmitting, by processing hardware to a base station, a request to configure a tunnel associated with an MBS session, via which the CN is to transmit MBS data to the base station for wireless transmission to multiple UEs; and receiving, by the processing hardware from the base station, a configuration of the tunnel.

Example 26. The method of example 25, further comprising: receiving, by the processing hardware from a UE, a request to join the MBS session, wherein transmitting the request to configure the tunnel is responsive to the request to join the MBS session.

Example 27. The method of example 25, further comprising: receiving, by the processing hardware from a UE, after transmitting the request to configure the tunnel, a request to join the MBS session.

Example 28. The method of example 26 or 27, further comprising: transmitting, by the processing hardware to the base station, MBS data via the tunnel for wireless transmission to the UE.

Example 29. The method of example 26 or 27, wherein the UE is a first UE and the request to join the MBS session is a first request, the method further comprising: receiving, by the processing hardware from a second UE, a second request to join the MBS session; and transmitting, by the processing hardware to the base station, MBS data for the first UE and the second UE via the tunnel.

Example 30. The method of example 25, wherein transmitting the request includes: excluding, by the processing hardware, from the request, configuration parameters for utilizing the tunnel for transmissions from the base station to the CN.

Example 31. The method of example 25, wherein the configuration includes an IP address.

Example 32. The method of example 25 or 31, wherein the configuration includes a tunnel identifier.

Example 33. The method of any one of examples 25 or 31-32, wherein the request includes an identifier of the MBS session.

Example 34. The method of any one of examples 25 or 31-33, wherein the request includes a quality of service configuration for the MBS session.

Example 35. The method of any one of examples 25 or 31-34, wherein the request identifies one or more quality of service flows for the MBS session.

Example 36. A core network including processing hardware and configured to implement a method according to any one of examples 25-35.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a base station for managing transmission of multicast and/or broadcast services (MBS), the method comprising:
receiving, by the base station from a core network (CN), a request to configure a common tunnel associated with an MBS session, via which the base station is to receive MBS data, from the CN, for wireless transmission to multiple user equipment (UEs); and
in response to the request, transmitting, by the base station to the CN, a configuration of the common tunnel.

2. The method of claim 1, further comprising:
configuring, by the base station, a logical channel associated with a radio interface and corresponding to the common tunnel;
receiving, by the base station, the MBS data from the CN via the common tunnel; and
transmitting, by the base station, the MBS data to the multiple UEs via the logical channel over the radio interface.

3. The method of claim 2, wherein:
configuring the logical channel includes configuring the logical channel for multiple quality of service (QOS) flows for the MBS session;
receiving the MBS data includes receiving the MBS data associated with the multiple QoS flows; and
transmitting the MBS data includes transmitting the MBS data associated with the multiple QoS flows via the logical channel.

4. The method of claim 2, wherein:
the configuring includes configuring a plurality of logical channels; the method further comprising:
mapping a multiplicity of QoS flows in the MBS data to the plurality of logical channels.

5. The method of claim 2, further comprising:
configuring, by the base station, a multicast radio bearer (MRB) for transmitting data received via the common tunnel; and
wherein transmitting the MBS data includes using the MRB.

6. The method of claim 5, wherein the configuring includes:
associating the MRB with a logical channel associated with the common tunnel.

7. The method of claim 1, further comprising:
receiving, by the base station, the MBS data via the common tunnel; and
in response to determining that the common tunnel is associated with the MBS session, selecting a logical channel via which to transmit the MBS data.

8. The method of claim 1, further comprising:
receiving, by the base station, the MBS data via the common tunnel; and
in response to determining that the common tunnel is configured for receiving the MBS data for multiple UEs, selecting a logical channel via which to transmit the MBS data.

9. The method of claim 1, further comprising:
based on at least one of an Internet Protocol (IP) address or a tunnel identifier of a received data packet, determining whether the data packet arrived via the common tunnel associated with the MBS session or a tunnel configured for a particular UE; and
selecting a logical channel via which to transmit the data packet based on the determining.

10. The method of claim 1, further comprising:
receiving, by the base station, the MBS data via the common tunnel; and
based on determining whether the MBS data is broadcast data or multicast data, selecting a logical channel via which to transmit the MBS data.

11. The method of claim 1, wherein the selecting includes selecting at least one of a multicast traffic channel or a dedicated traffic channel.

12. The method of claim 1, further comprising:
configuring, by the base station, a multicast radio bearer (MRB) for the MBS session;
assigning, by the base station, a first identifier to the MRB;
configuring, by the base station, a data radio bearer (DRB) for a particular UE;
assigning, by the base station, a second identifier to the DRB.

13. The method of claim 12, wherein assigning the first identifier and assigning the second identifier include selecting the first identifier and the second identifier from an overlapping number space.

14. The method of claim 12, wherein assigning the first identifier and assigning the second identifier include selecting the first identifier and the second identifier from non-overlapping number spaces.

15. A base station including processing hardware and configured to:
receive, from a core network (CN), a request to configure a common tunnel associated with a multicast and/or broadcast services (MBS) session, via which the base station is to receive MBS data, from the CN, for wireless transmission to multiple user equipment (UEs); and
in response to the request, transmit, to the CN, a configuration of the common tunnel.

16. The base station of claim 15, further configured to:
configure a logical channel associated with a radio interface and corresponding to the common tunnel;
receive the MBS data from the CN via the common tunnel; and
transmit the MBS data to the multiple UEs via the logical channel over the radio interface.

17. The base station of claim 16, wherein:
to configure the logical channel, the base station configures the logical channel for multiple quality of service (QOS) flows for the MBS session;
to receive the MBS data, the base station is configured to receive the MBS data associated with the multiple QoS flows; and
to transmit the MBS data, the base station is configured to transmit the MBS data associated with the multiple QoS flows via the logical channel.

18. The base station of claim 16, wherein:
the base station configures a plurality of logical channels;
the base station is further configured to:
map a multiplicity of QoS flows in the MBS data to the plurality of logical channels.

19. The base station of claim 16, further configured to:
configure a multicast radio bearer (MRB) for transmitting data received via the common tunnel; and
wherein to transmit the MBS data, the base station is configured to use the MRB.

20. The base station of claim 15, further configured to:
receive the MBS data via the common tunnel; and
in response to determining that the common tunnel is associated with the MBS session, select a logical channel via which to transmit the MBS data.
